(19) United States
(12) Patent Application Publication
(10) Pub. No.: US 2013/0199391 A1
(43) Pub. Date: Aug. 8, 2013

(54) METHOD FOR PRODUCING A CONTROL AREA FOR OFFSET PRINTING, CONTROL AREA AND PRINTING FORM HAVING A CONTROL AREA

(71) Applicant: HEIDELBERGER DRUCKMASCHINEN AG, Heidelberg (DE)

(72) Inventors: KLAUS OLAWSKY, WEINHEIM (DE); AXEL HAUCK, KARLSRUHE (DE); MATTHIAS SCHLOERHOLZ, PLANKSTADT (DE)

(73) Assignee: HEIDELBERGER DRUCKMASCHINEN AG, HEIDELBERG (DE)

(21) Appl. No.: 13/762,873

(22) Filed: Feb. 8, 2013

(30) Foreign Application Priority Data
Feb. 8, 2012 (DE) 10 2012 002 452.5

(51) Int. Cl. B41N 3/00

(52) U.S. Cl. CPC B41N 3/006
USPC 101/492; 101/368

(57) ABSTRACT

A method for producing a control area to prevent scumming of a printing form that can be used for offset printing with dampening solutions, includes producing the control area separately from the printing form and joining the control area to the printing form thereafter. A cut-out is introduced into the printing form and the control area is inserted into the cut-out. A control area and a printing form having a control area are also provided.

### CROSS-REFERENCE TO RELATED APPLICATION

This application claims the priority, under 35 U.S.C. §119, of German Patent Application DE 10 2012 002 452.5 filed Feb. 8, 2012; the prior application is herewith incorporated by reference in its entirety.

### BACKGROUND OF THE INVENTION

### Field of the Invention

The invention relates to a method for producing a control area to prevent scumming of a printing form that can be used for offset printing with dampening solutions, in which the control area is produced separately from the printing form and joined to the latter thereafter. The invention also relates to a control area and a printing form having a control area.

Such control areas indicate the reaching or imminent reaching of the so-called smearing point, at which the printing form begins to scum as a result of a lack of dampening solution.

In German Patent Application DE 10 2008 027 035 A1, corresponding to U.S. Pat. No. 8,037,816, a measuring area is described which is produced separately from the printing form, for example on film, and is applied to the surface of the printing form, for example adhesively bonded on.

The disadvantage thereof is that the measuring area which is bonded on projects from the surface of the printing form and, as a result, can lead to printing defects in the adjacent printing form areas.

### SUMMARY OF THE INVENTION

It is accordingly an object of the invention to provide a method for producing a control area for offset printing, a control area and a printing form having a control area, which overcome the hereinafore-mentioned disadvantages of the heretofore-known methods, control areas and printing forms of this general type and in which impairment to neighboring areas is avoided or at least reduced.

With the foregoing and other objects in view there is provided, in accordance with the invention, a method for producing a control area to prevent scumming of a printing form that can be used for offset printing with dampening solutions. The method comprises producing the control area separately from the printing form and joining the control area to the printing form thereafter by introducing a cut-out into the printing form and inserting the control area into the cut-out.

The advantage of the method according to the invention is that the control area produced thereby no longer projects from the printing form surface and thus no longer impairs the printing quality.

In accordance with another mode of the invention, the control area is produced in the form of a surface structure differing from an image grid of the printing form. In this case, the surface structure can be produced by using at least one abrasive machining process, such as grinding, lapping or sanding.

In accordance with a further mode of the invention, the surface structure is produced by irradiation using a laser.

In accordance with an added mode of the invention, the surface structure is produced by using a solvent.

In accordance with an additional mode of the invention, the surface structure is produced as an irregular and, for example, stochastic surface structure.

In accordance with yet another mode of the invention, the printing form is a positive plate.

With the objects of the invention in view, there is also provided a control area which is produced by the method according to the invention or a method corresponding to one of the modes or developments thereof.

With the objects of the invention in view, there is concomitantly provided a printing form which comprises such a control area.

Other features which are considered as characteristic for the invention are set forth in the appended claims.

Although the invention is illustrated and described herein as embodied in a method for producing a control area for offset printing, a control area and a printing form having a control area, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIGS. 1A-1C are fragmentary, diagrammatic, cross-sectional views showing various stages in the production of a control area;

FIGS. 2-5C are fragmentary, elevational views showing tools that can be used to produce the control area;

FIGS. 6A-6E are fragmentary, partly sectional views showing an introduction of the control area into a printing form; and

FIGS. 7A-7C are fragmentary, cross-sectional views showing various stages in the production of another control area.

### DETAILED DESCRIPTION OF THE INVENTION

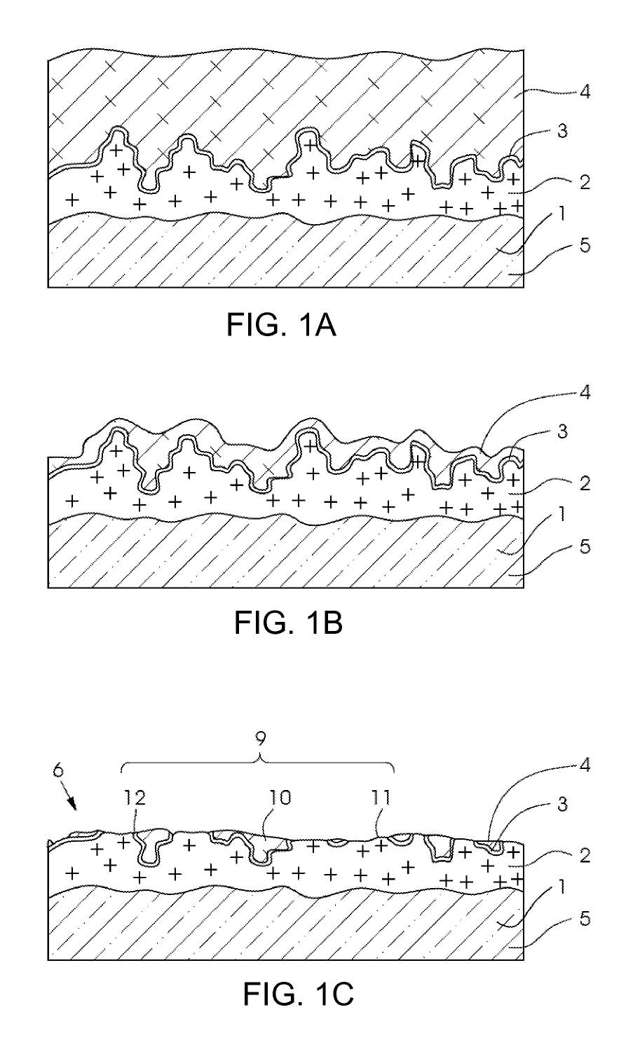

Referring now to the figures of the drawings in detail and first, particularly, to FIG. 1A thereof, there is seen a blank of a printing form 5 for use as a positive plate in offset printing with dampening solution. Disposed at the bottom of the printing form 5 is a first layer 1, which is formed of aluminum and forms a carrier material. The first layer 1 is about 0.3 mm thick and has a roughness of a few micrometers. Located above this first layer 1 is a second layer 2, which is formed predominantly of aluminum oxide (Al₂O₃) and is about one micrometer thick. The second layer 2 is fissured and forms peaks and valleys. There follows a third layer 3, which is formed of polyvinyl phosphonic acid and is about one nanometer thick. The third layer 3 forms an intermediate layer and can be designated a sealing layer or contact layer. An upper termination is formed by a fourth layer 4, which is a plastic layer and can be temperature-sensitive or light-sensitive as a photopolymer layer. The fourth layer 4 is about 2 micrometers thick. The fourth layer 4 can also be composed of two or more different plastic layers.

The illustrated area of the printing form 5, following its processing explained below, forms a control area 6 for controlling the amount of dampening solution. In the event of an increasing lack of dampening solution during printing operation, the control area 6 scums earlier than the non-printing areas of the printing form 5, so that, through the use of an increase in the supply of dampening solution then carried out, for example in an automated manner, the scumming of the non-printing areas can be reliably avoided. The control area 6 is a smearing point indicator and is distinguished by a quasi-linear functional relationship of the ink density as a function of the amount of dampening solution. Due to the quasi-linearity, the control area 6 is particularly well suited to dampening solution control and regulation.

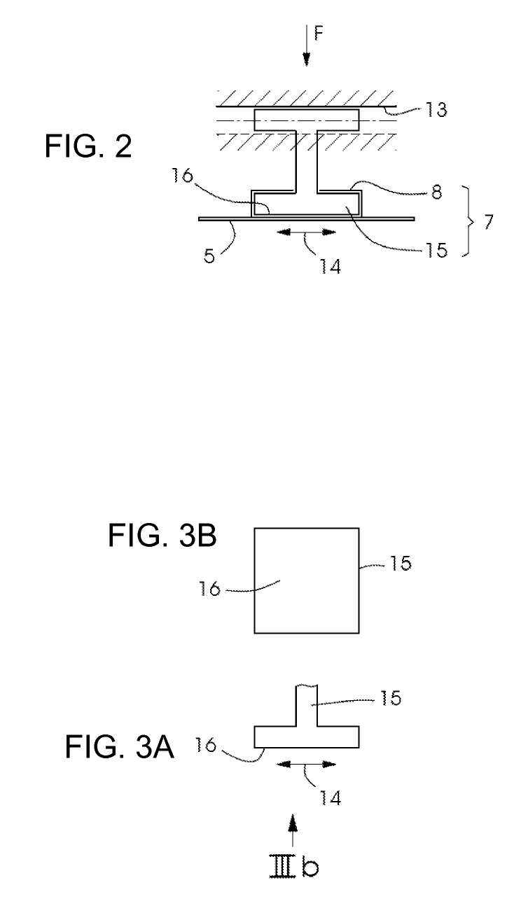

FIG. 1B shows the printing form 5 in the area of the control area 6 after a first processing step for producing the control area 6. In the first processing step, the printing form 5 is processed mechanically and chemically through the use of a tool 7 (compare FIGS. 2 to 5). In this case, through the use of the tool 7, a scouring, grinding or wiping load is exerted on the fourth layer 4, as a result of which the latter is for the most part removed. In this case, the fourth layer 4 is simultaneously treated with a solvent, for example acetone. The tool 7 can be impregnated with the solvent. The third layer 3 and the fourth layer 4 are present in the valleys of the second layer 2. The third layer 3 is located on the peaks of the second layer 2, and the fourth layer 4 is located in rudimentary form only at some points.

FIG. 1C shows the area of the control area 6 to be produced following a second processing step, in which, through the use of the tool 7 or a replacement tool, a scouring, grinding or wiping movement has again been exerted on the surface of the printing form 5. In this case, however, instead of the solvent, a liquid or pasty scouring agent is used which, with respect to its pH, can be neutral to slightly alkaline. The scouring agent can, for example, be a water-soluble liquid with extremely fine abrasive particles. The tool 7 can have a textile, woven or nonwoven-like cloth 8 (compare FIGS. 2 to 5), which forms the scouring area and can be impregnated with acetone and the scouring agent. The cloth 8 can be replaced by a new one between the first and the second processing steps.

Following the second processing step, the peaks of the original relief of the second layer 2 have to some extent been ground off and the third layer 3 has also been ground off at the ground-off points. Small quantities of the third layer 3, and on the latter, still smaller quantities of the fourth layer 4, remained substantially only in the area of the valleys. A surface structure in the form of a mixed surface 9 has been produced which, beside one another, has ink-carrying or printing areas 10, indifferent areas 11 and non-ink-carrying or non-printing areas 12, which together form a largely even profile. The mixed surface 9 imparts the property of a non-screened printing image to the control area 6 during printing and, depending on the supply of dampening solution, is more or less covered with ink. It is no longer possible to detect, through the use of a magnifying glass, whether or not the mixed surface 9 has digital ink acceptance properties as in the case of a screened printing image.

During both of the processing steps explained, the tool 7 is pressed against the printing form 5 with a pressure of 0.05 to 0.15 newtons per square millimeter and is moved back and forth on the latter linearly or with a circulating movement, in order to produce the scouring action. The processing time during each processing step is a few seconds and can be defined exactly in advance, as can the number of back and forth movements (scouring frequency).

FIG. 2 shows the tool 7 during production of the control area 6. In this case, the tool 7 is moved back and forth along a linear guide 13 through the use of a non-Illustrated drive. This back and forth movement 14 is carried out under the action of a force F, through which the tool 7 is pressed against the surface of the printing form 5. The back and forth movement 14 is carried out in a direction which is predefined by the guide 13 and which is parallel to the subsequent circumferential direction of the printing form 5 on a printing form cylinder or to an unwinding direction of the printing form 5 illustrated in the unwound state in the drawing. The tool 7 includes a plunger 15, on which the cloth 8 is clamped. The plunger 15 has a pressure surface 16, through which the cloth 8 is pressed against the printing form 5.

FIGS. 3A and 3B show a first exemplary embodiment of the plunger 15, in which the pressure surface 16 is a rectangular flat surface.

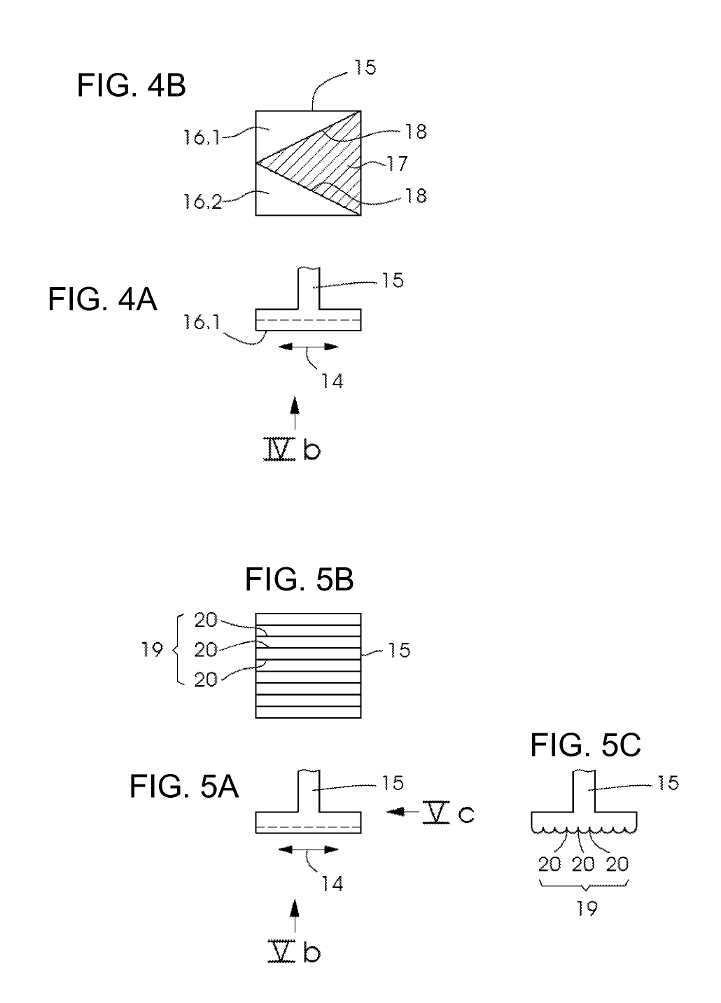

FIGS. 4A and 4B show a second exemplary embodiment of the plunger 15, in which the pressure surface 16 is subdivided into a plurality of, specifically two, projecting partial surfaces 16.1, 16.2, between which there is a recessed surface 17 without any contact with the cloth 8. The partial surfaces 16.1 and 16.2 are triangular and have edges 18 running obliquely with respect to the direction of the back and forth movement 14 and diverging mirror-symmetrically from each other. As a result of the wedge shape, a non-constant processing intensity is achieved transversely with respect to the back and forth movement 14, as a result of which, in the printing process, a corresponding locally different ink/dampening solution absorption behavior is established in the control area 6. This means that changes in the supply of ink and the supply of dampening solution over a greater evaluation range and with greater excursions of the measured ink density are represented.

FIGS. 5A to 5C show a third exemplary embodiment of the plunger 15, in which the pressure surface 16 has ribbing 19 with ribs 20 which run parallel to the direction of the back and forth movement 14. In a non-illustrated modification, the ribbing 19 is not introduced into the plunger 15 but directly into the cloth 8, for example as a woven structure.

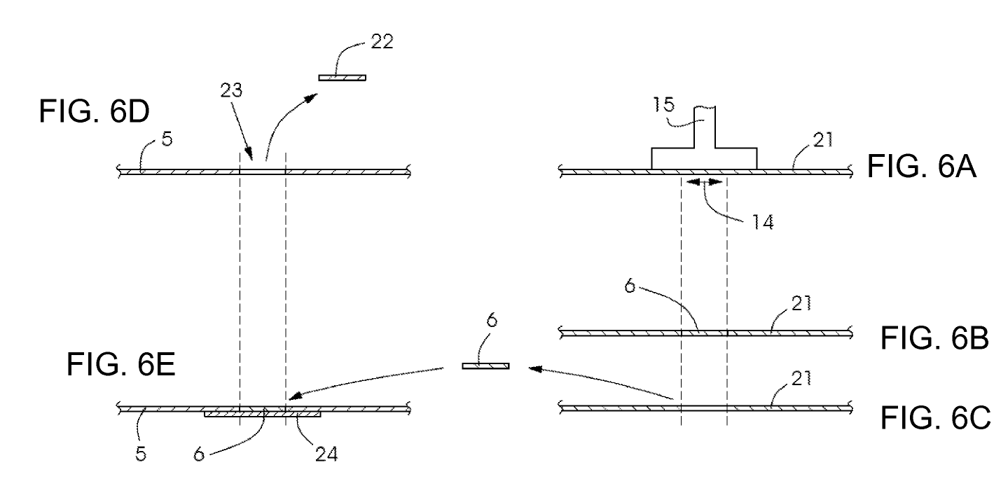

In FIGS. 6A to 6E, an exemplary embodiment of the invention is shown in which the control area 6 has been produced separately from the printing form 5 and subsequently joined to the latter.

FIG. 6A shows a processing plate 21 which is processed through the use of the tool 7 in the manner which has already been described in relation to FIGS. 1 to 5. The processing plate 21 can be a printing form blank. The processing takes place according to the steps which are shown in FIGS. 1A to 1C.

FIG. 6B shows the processing plate 21 after one or more control areas 6 have been produced on the latter by the processing through the use of the tool 7. For reasons of illustrative simplification, the production of only a single control area 6 has been shown. In practice, however, a multiplicity of identical control areas 6 are produced from the processing plate 21. These control areas can be disposed beside one another, for example in the form of a rectangular grid. In this variant, the processing plate 21 could be broken down into the multiplicity of control areas 6 through the use of a plurality of mutually perpendicular cuts, for example laser cuts.

FIG. 6C shows that the control area 6 shown has been separated out from the remaining processing plate 21.

FIG. 6D shows that a piece 22 with the same coverage as the control area 6 has been cut out of a printing form 5, for example likewise through the use of a laser, so that a cut-out 23 has been produced in the printing form 5.

FIG. 6E shows that the control area 6 has been introduced into the cut-out 23 with an exact fit. The control area 6 is adhesively bonded to the printing form 5 in order to firmly connect the control area 6 inserted into the printing form 5 to the printing form 5. A thin underlay 24, which is disposed on the underside of the printing form 5, is somewhat larger than the cut-out 23 and projects around the latter. The part of the underlay 24 overlapping the cut-out 23 is firmly connected to the printing form 5, for example adhesively bonded, and the part of the underlay 24 located in the area of the cut-out 23 is firmly connected to the control area 6 inserted into the cut-out 23, for example adhesively bonded. The underlay 24 can be a plastic film or a metal foil, for example a self-adhesive film or foil. Since the processing plate 21 and the printing form are formed of the same semi-finished product, the control area 6 which is inserted is exactly as thick as the printing form 5 and flush with the functional surface of the latter.

In a modification not shown in the drawing, it is possible to dispense with the underlay 24. In this case, the cut-out 23 has inner walls which run toward each other in the shape of a wedge, for example in the shape of a hollow cone or funnel, toward the upper side of the printing form 5. The cut-out 23 is tapered toward the upper side. The control area 6 has side surfaces, for example cut surfaces, which fit the inner walls accurately and which likewise run toward each other in the shape of a wedge, for example in the shape of a cone or pyramid. The control area 6 is tapered toward the upper side. When the control area 6 is inserted into the cut-out 23, the former is increasingly wedged in the latter when a force, for example brought about by ink splitting, acts on the control area 6 and attempts to pull the latter out of the cut-out 23 toward the upper side.

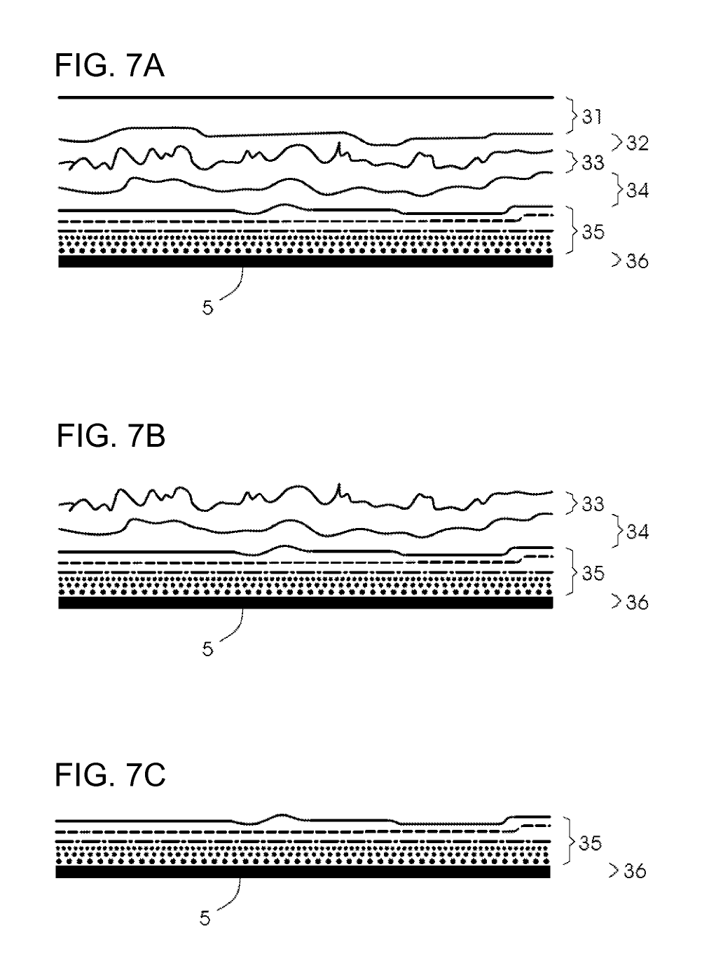

FIGS. 7A to 7C show a further exemplary embodiment of the surface processing of a blank of the printing form 5 for the purpose of producing the control area 6 on the printing form 5.

FIG. 7A shows an initial state of the blank, in which a first layer 31, a second layer 32, a third layer 33, a fourth layer 34 and a fifth layer 35 are disposed from top to bottom in the aforementioned order. The first layer 31 is a photosensitive polymer layer. The second layer 32 is an intermediate layer and is formed of polyvinyl phosphonic acid. The third layer 33 is an amorphous aluminum oxide layer (AlOₓ). The fourth layer 34 is an aluminum oxide layer (Al₂O₃ layer). The fifth layer 35 is a mixture composed of aluminum and aluminum oxide (Al₂O₃). The sixth layer 36 is formed of metallic aluminum.

In FIG. 7A, the printing form 5 is shown before its processing.

Starting from a conventional printing plate, in one step the ink-carrying polymer layer, the organic intermediate layer (polyvinyl phosphonic acid) and the amorphous oxide layer are largely removed by grinding. The printing plate area obtained in this way is distinguished by a printing behavior that depends on the amount of dampening solution and thus represents the control area 6.

FIG. 7B shows the printing form 5 following the removal of the two polymer layers in a cross-sectional illustration.

FIG. 7C shows the printing form 5 with metallic components on the surface.

According to a modification, the ink-carrying polymer layer and the adhesion-promoting intermediate layer can be removed chemically through the use of a solution. To this end, in a first step the ink-carrying polymer layer is dissolved with ethanol and rinsed off. In a second step, the adhesion-promoting polyvinyl phosphonic acid is removed by oxidation with a 10% aqueous hydrogen peroxide solution through an approximately 10 min action on the region of the polymer layer-free dampening solution control area of the printing plate. In a last process step, the printing plate (printing form 5) is rinsed with water.

The control area 6 produced in accordance with FIGS. 7A to 7C can also be inserted into a printing form 5 in accordance with FIGS. 6A to 6E if, during the production of the control area 6, instead of the printing form a processing plate is used, from which the control area is cut out.

Various modifications are possible. For instance, the control area 6 can be covered with a nano-scale or microscopic layer. According to another modification, only the ink-carrying polymer layer of the printing form 5, that is to say the first layer 31, is removed in order to produce the control area 6.

Alternatively, it is also possible not to remove the layer or layers mechanically or chemically but through the use of electromagnetic radiation, for example through the use of a laser. For example, that laser which is later used for exposing the positive plate (printing form 5) in accordance with a printing image can be operated with a laser power reduced as compared with the aforesaid exposure, in order to produce the control area 6. The printing form 5 is then developed, with the result being similar surface properties to those in the case of removal by grinding. In this case, the laser cross-links the polymer layer and, as a result, leads to stabilization. If exposure is carried out with reduced laser power, the cross-linking is lower and layer residues remain on the surface, for example in the pores, during the development.

1. A method for producing a control area to prevent scumming of a printing form to be used for offset printing with a dampening solution, the method comprising the following steps:
producing the control area separately from the printing form;
introducing a cut-out into the printing form;
inserting the control area into the cut-out; and
then joining the control area to the printing form.

2. The method according to claim 1, which further comprises producing the control area in the form of a surface structure differing from an image grid of the printing form.

3. The method according to claim 2, which further comprises producing the surface structure by using at least one machining process selected from the group of machining processes including grinding, lapping and sanding.

4. The method according to claim 2, which further comprises producing the surface structure by laser radiation.

5. The method according to claim 2, which further comprises producing the surface structure by using a solvent.

6. The method according to claim 2, which further comprises producing the surface structure as an irregular surface structure.

7. The method according to claim 1, wherein the printing form is a positive plate.

8. A control area produced by the method according to claim 1.

9. A printing form, comprising a control area produced by the method according to claim 1.
